(19) United States
(12) Patent Application Publication
(10) Pub. No.: US 2025/0388732 A1
(43) Pub. Date: Dec. 25, 2025

(54) APPARATUS FOR MANUFACTURING CLOSED-CELL FOAM AND METHODS THEREOF

(71) Applicant: Double Dragon Assets Limited, Road Town (VG)

(72) Inventor: Fang LI, Road Town (VG)

(73) Assignee: Double Dragon Assets Limited, Road Town, VG (VG)

(21) Appl. No.: 18/752,793

(22) Filed: Jun. 25, 2024

(51) Int. Cl. C08J 9/12

(52) U.S. Cl. CPC C08J 9/122; C08J 2203/06; C08J 2205/052; C08J 2327/16

(57) ABSTRACT

The present invention provides an apparatus and a method for manufacturing a closed-cell foam. The apparatus comprises one, two or more processing units and a terminal unit. Each of the processing units includes a recess for accommodating one single slab to be expanded to the closed-cell foam. The apparatus also includes a sealable trans-unit gas system for delivering foaming gas, and a sealable trans-unit liquid system for controlling the temperature of the units. The invention exhibits numerous technical merits such as better cost-effectiveness, higher production efficiency, easy and convenient one-step foam preparation, higher precision in controlling the foam's Barcol hardness, and environmentally friendly process, among others.

### FIELD OF THE INVENTION

The present invention generally relates to an apparatus for manufacturing closed-cell foams and methods thereof. Although the invention will be illustrated, explained and exemplified by an apparatus and a method for manufacturing closed-cell foams of polyvinylidene difluoride (PVDF), it should be appreciated that the present invention can also be applied to other fields, for example, closed-cell foams of Perfluoroalkoxy alkanes (PFA), Polypropylene (PP), Polyethylene (PE), Polyamide (PA), Polyvinyl chloride (PVC), Ethylene-vinyl acetate (EVA), Thermoplastic polyurethane (TPU), Polyether ether ketone (PEEK), block copolymers of polyether and polyamide such as Pebax®, and the like.

### BACKGROUND OF THE INVENTION

Microcellular polymer foams (MPFs) are emerging class of polymeric materials that may eventually replace solid plastics in a wide range of commercial applications. Microcellular foams offer multiple advantages relative to their solid analogs, e.g. substantial material savings, decreased processing/transportation costs and improved mechanical properties. Microcellular foamed plastics typically exhibit high impact strength, toughness, stiffness-to-weight ratio and thermal stability, as well as a low dielectric constant and thermal conductivity, relative to their solid analogs. These unique properties make MPFs ideally suited for a large number of contemporary technologies including automotive parts with high strength-to-weight ratio, acoustic dampening, sporting equipment with reduced weight and high energy absorption, food packaging and insulation with reduced material costs, molecular sieves for separation processes, low dielectric insulators for microelectronic applications, surface modifiers to reduce friction, and biomedical materials for controlled drug delivery.

Supercritical foaming technology utilizes supercritical fluids (SCFs) as foaming agents, particularly supercritical carbon dioxide (ScCO2) and supercritical nitrogen (ScN2). The process involves subjecting polymers to SCF under controlled conditions of pressure and temperature, leading to the formation of uniform and finely structured foams. This technology not only enhances foam production efficiency but also significantly reduces its environmental footprint.

For example, polyvinylidene fluoride or polyvinylidene difluoride (PVDF) is a highly non-reactive thermoplastic fluoropolymer produced by the polymerization of vinylidene difluoride. PVDF has a strong toughness and high elasticity, and has a high chemical, weathering, permeation and flammability resistance. However, PVDF has a relatively high density, and can be more expensive. Therefore, there is a need to reduce the density and the cost of PVDF, with little or no decrease in its excellent physical and chemical properties. A known approach to reduce the density of PVDF is formation of a PVDF foam. Generally, foam may be formed by trapping pockets of gas in a solid. In closed-cell foam, the gas forms discrete pockets (rather than interconnected pores), each being surrounded completely by the solid material. The closed-cell foams have higher dimensional stability, low moisture absorption coefficients, and higher strength, as compared to open-cell foams.

PVDF foam board is a kind of gas-solid two-phase foam material obtained by introducing a large amount of inert gas bubbles into PVDF sheets through physical foaming techniques. It aims to reduce material usage and product weight. Due to the unique properties of PVDF materials and the cleanliness and environmental friendliness of this physical foaming process, PVDF foam board materials can be applied in special fields and industries such as micro-electronics, aerospace, pharmaceuticals, and food and beverage.

When using inert physical foaming gases such as CO2 and N2, the PVDF sheet is heated to a semi-solid temperature where it is deformable but not yet flowable. At this temperature, inert foaming gas diffuses into the PVDF sheet matrix under pressure until dissolution equilibrium is reached. Upon pressure relief, the inert gas bubbles are induced to nucleate and promote bubble growth, achieving foaming of the PVDF sheet. This semi-solid physical foaming process is clean and environmentally friendly.

However, current methods for preparing polymer foam materials typically involve physical blending or chemical modification during the preparation process, which can affect the properties of PVDF materials themselves. Additionally, PVDF belongs to ultra-high molecular weight polymers, making it difficult to obtain foam products through a one-step foaming process. Secondary foaming process is often required, which significantly affects production efficiency and incurs high costs for the equipment needed for two-steps foaming.

Advantageously, the present invention provides a novel apparatus such as a specially designed plate heat exchanger to control the temperature, inert foaming gas pressure, and foaming time, enabling the easy and convenient one-step foaming preparation of PVDF foam board materials with different volume expansion ratios and Barcol hardness values.

### SUMMARY OF THE INVENTION

One aspect of the present invention provides an apparatus for manufacturing a closed-cell foam. The apparatus comprises one, two or more processing units and a terminal unit. Each of the processing units includes a main body with a front side and a rear side. The front side has a recess for partially or fully accommodating one single slab made of dense material with a density D0. The slab is to be expanded to the closed-cell foam having a density Df<D0. The recess' mouth can be pressed against the rear side of another processing unit or a side of the terminal unit to seal the mouth. Each of the processing units also includes a gas entry conduit configured for delivering a gas flow to the recess through the main body; a gas exit conduit configured for releasing the gas within the recess through the main body; and a heating and cooling system for controlling the temperature of all the processing units and the terminal unit.

Another aspect of the invention provides a method of manufacturing a closed-cell foam using the apparatus as described above. The method comprises the following steps: (i) placing one single slab made of dense material having a density D0 in the recess; (ii) engaging the processing units and the terminal unit with each other by pressing or clamping them against each other, so that the recess' mouth is pressed against the rear side of another processing unit or a side of the terminal unit to seal the mouth; (iii) delivering a gas medium with a predetermined pressure P that is higher than the atmospheric pressure P0 around each of the slabs; (iv) adjusting the temperature of the gas medium as well as the slabs to a predetermined temperature T using the heating and cooling system; (v) dissolving or diffusing an amount of the gas molecules into each of the slabs under the predetermined pressure P and the predetermined temperature T for a predetermined time period t; (vi) lowering or reducing the pressure of the gas medium around each of the slabs down to the atmospheric pressure P0 and disengaging the processing units and the terminal unit from each other, to allow each of the slabs be expanded to the closed-cell foam having a density Df<D0.

The above features and advantages and other features and advantages of the present invention are readily apparent from the following detailed description of the best modes for carrying out the invention when taken in connection with the accompanying drawings.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements. All the figures are schematic and generally only show parts which are necessary in order to elucidate the invention. For simplicity and clarity of illustration, elements shown in the figures and discussed below have not necessarily been drawn to scale. Well-known structures and devices are shown in simplified form, omitted, or merely suggested, in order to avoid unnecessarily obscuring the present invention.

FIG. 1 schematically illustrates a general apparatus containing multiple processing units and a terminal unit in accordance with exemplary embodiments of the present invention.

FIG. 2 schematically illustrates the apparatus in an engaged mode in accordance with an exemplary embodiment of the present invention.

FIG. 3 schematically illustrates the apparatus in a disengaged mode in accordance with an exemplary embodiment of the present invention.

FIG. 4 demonstrates some structural details of the processing units and the terminal unit in accordance with an exemplary embodiment of the present invention.

FIG. 5 demonstrates some structural details of the processing units and the terminal unit in accordance with another exemplary embodiment of the present invention.

FIG. 6 schematically shows some structural details of the gas entry conduit and the gas exit conduit in accordance with an exemplary embodiment of the present invention.

FIG. 7 schematically illustrates a mechanism for engaging the processing units and the terminal unit in accordance with an exemplary embodiment of the present invention.

FIG. 8 schematically illustrates a sealed trans-unit gas system formed when the apparatus is in the engaged mode in accordance with an exemplary embodiment of the present invention.

FIG. 9 illustrates an external heater in the apparatus in accordance with an exemplary embodiment of the present invention.

FIG. 10 illustrates an internal heater in the apparatus in accordance with an exemplary embodiment of the present invention.

FIG. 11 depicts a schematic design of the heating and cooling system in accordance with an exemplary embodiment of the present invention.

FIG. 12 schematically illustrates a sealed trans-unit liquid system formed when the apparatus is in the engaged mode in accordance with an exemplary embodiment of the present invention.

FIG. 13 is the flow chart of a general method for manufacturing a closed-cell foam using the apparatus as described above in accordance with exemplary embodiments of the present invention.

FIG. 14 illustrates the step of placing a slab made of dense material in the recess in accordance with exemplary embodiments of the present invention.

FIG. 15 illustrates the step of engaging the processing units and the terminal unit with each other in accordance with exemplary embodiments of the present invention.

FIG. 16 illustrates the step of expanding the slabs to the closed-cell foam in accordance with exemplary embodiments of the present invention.

### DETAILED DESCRIPTION OF THE PREFERRED EMBODIMENT

In the following description, for the purposes of explanation, numerous specific details are set forth in order to provide a thorough understanding of the present invention. It is apparent, however, to one skilled in the art that the present invention may be practiced without these specific details or with an equivalent arrangement.

Where a numerical range is disclosed herein, unless otherwise specified, such range is continuous, inclusive of both the minimum and maximum values of the range as well as every value between such minimum and maximum values. Still further, where a range refers to integers, only the integers from the minimum value to and including the maximum value of such range are included. In addition, where multiple ranges are provided to describe a feature or characteristic, such ranges can be combined.

It is also to be understood that the terminology used herein is for the purpose of describing particular embodiments only, and is not intended to limit the scope of the invention. For example, when an element is referred to as being “on”, “connected to”, or “coupled to” another element, it can be directly on, connected or coupled to the other element or intervening elements may be present. In contrast, when an element is referred to as being “directly on”, “directly connected to”, or “directly coupled to” another element, there are no intervening elements present.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments of the invention may be readily combined without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In the description of the present invention, it should be noted that unless otherwise specified and limited, terms such as “installation”, “multilayer”, “connection”, “linking” should be broadly understood. For example, it can be a fixed connection, a detachable connection, or an integral connection; it can be a mechanical connection or an electrical connection; it can be a direct connection or an indirect connection through an intermediate medium; it can be vertically or horizontally connected, and it can be a connection inside two components. For ordinary skilled workers in the field, the specific meanings of these terms in the present invention can be understood according to specific situations.

In the following embodiments, if specific experimental steps or conditions are not specified, conventional experimental steps or conditions described in the literature in this field can be used. Reagents or instruments not specified by manufacturers are conventional reagent products that can be obtained through commercial purchases.

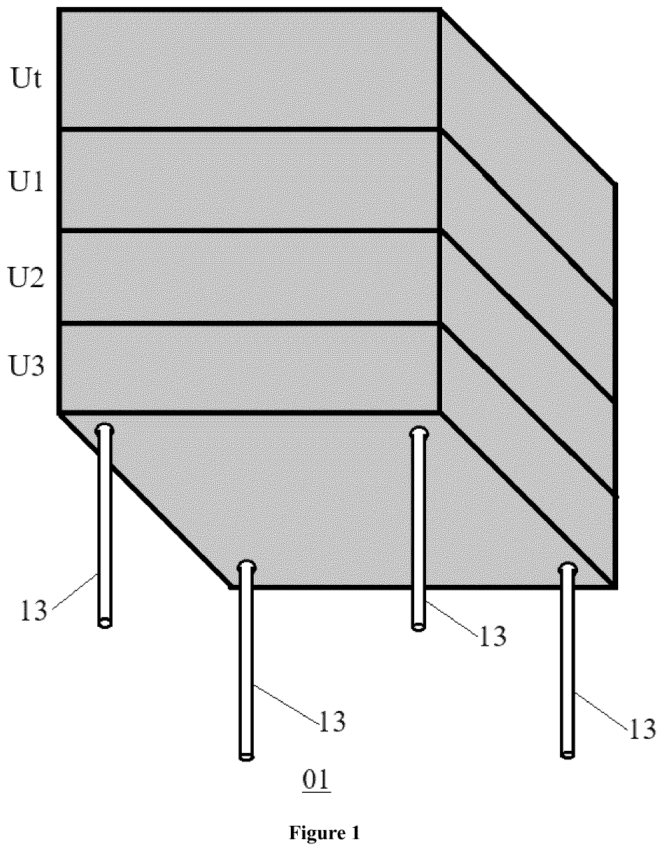

In various embodiments of the invention as schematically illustrated in FIG. 1, apparatus 01 is designed and used for manufacturing a closed-cell foam. A wide range of lightweight, crosslinked block foams 60 can be produced using inert gas expansion manufacturing process. Examples of the closed-cell foams 60 include, but are not limited to, polyvinylidene difluoride (PVDF), Perfluoroalkoxy alkanes (PFA), Polypropylene (PP), Polyethylene (PE), Polyamide (PA), Polyvinyl chloride (PVC), Ethylene-vinyl acetate (EVA), Thermoplastic polyurethane (TPU), Polyether ether ketone (PEEK), block copolymers of polyether and polyamide such as Pebax®, and the like.

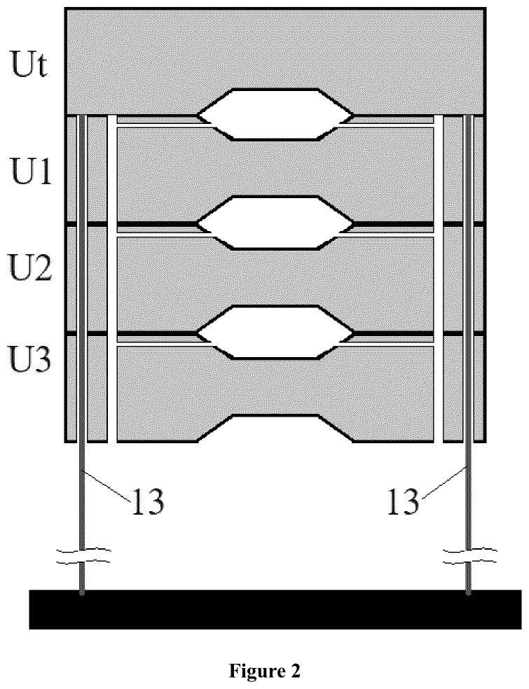

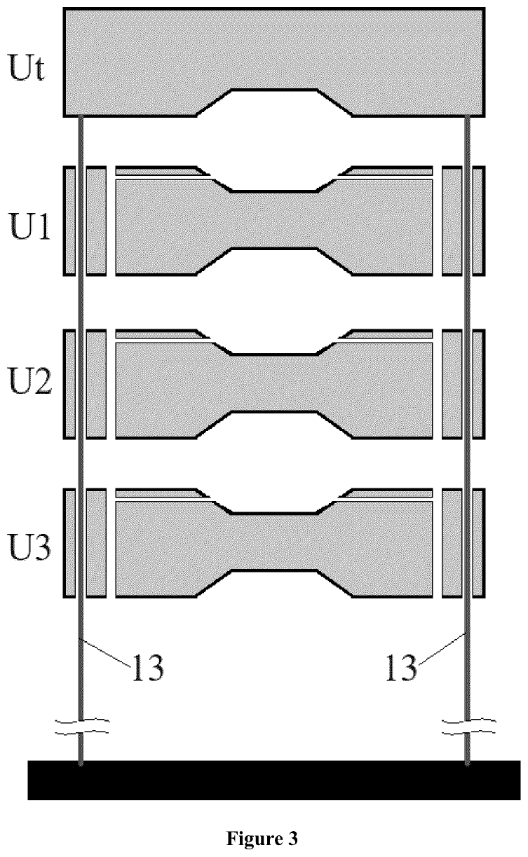

Apparatus 01 may contain one, two or more processing units (U1, U2 . . . Un) and a terminal unit Ut. These units may be stacked or arranged in serial vertically, horizontally or along any other orientations in between. In preferred embodiments, these units are stacked vertically with the terminal unit located at the highest position, as shown in FIG. 1. One or more sliding rods 13 may be used to precisely align all the processing units and the terminal unit in serial. The processing units may slide along rods 13 up and down so that all the processing units and the terminal may be stacked (or engaged) tightly to each other as shown in FIG. 2; or loosened (or disengaged or separated) from each other as shown in FIG. 3.

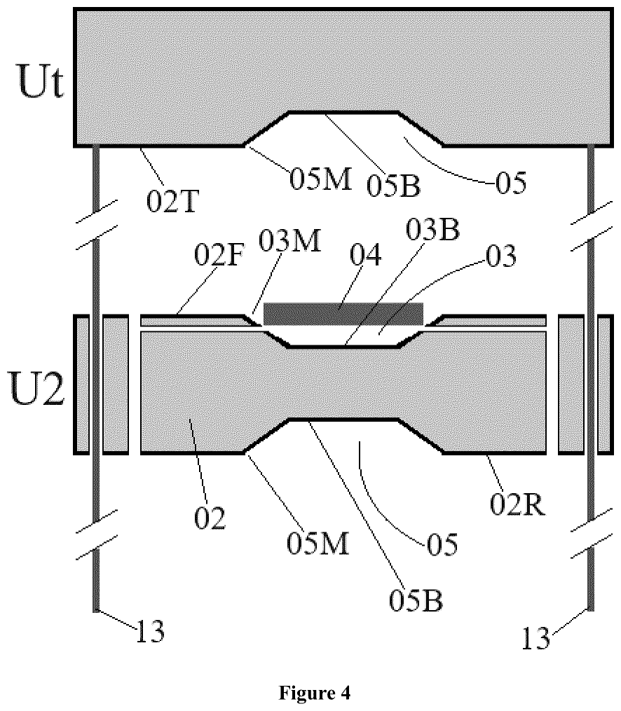

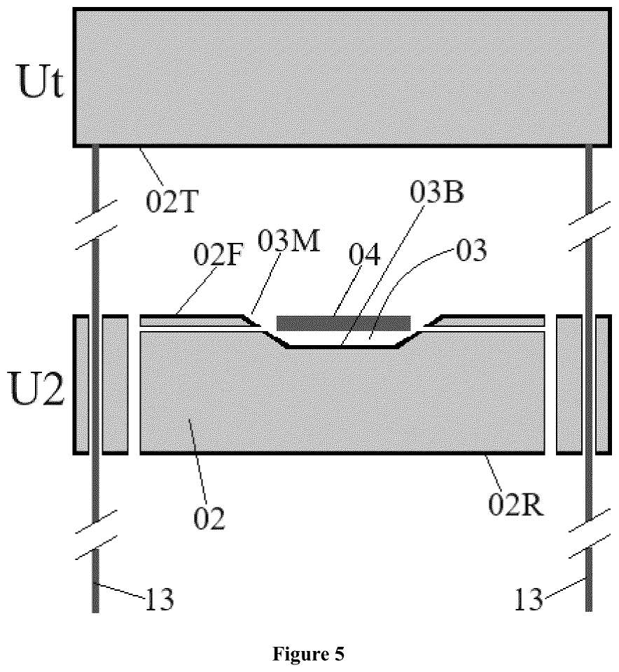

In exemplary embodiments as shown in FIG. 4 and FIG. 5, each of the processing unit(s) such as unit U2 includes a main body 02 with a front side 02F and a rear side 02R. The front side 02F may have a recess 03 for accommodating one single slab 04 partially or fully. Slab 04 may be made of dense material with a density of D0. Slab 04 may be made of a dense polymeric material selected from polyvinylidene difluoride (PVDF), Perfluoroalkoxy alkanes (PFA), Polypropylene (PP), Polyethylene (PE), Polyamide (PA), Polyvinyl chloride (PVC), Ethylene-vinyl acetate (EVA), Thermoplastic polyurethane (TPU), Polyether ether ketone (PEEK), block copolymers of polyether and polyamide such as Pebax®, or any combination thereof. Polymer and any additives (colors, fire retardants, conductive agents) may be extruded into a continuous solid plate. Sometimes, the plate passes through an oven, which activates the crosslinking process. The plate then cools and is cut into slabs. For example, slab 04 may be a piece of pure PVDF solid plate. The slab 04 will be expanded to a closed-cell foam (not shown) having a density Df<D0. When the processing units and the terminal are stacked (or engaged) tightly, the recess 03's mouth 03M can be pressed against the rear side 02R of another processing unit or a side 02T of the terminal unit Ut to seal the mouth 03M.

In some embodiments as shown in FIG. 4, the rear side 02F of each processing unit has a recess 05 with a mouth 5M that conforms to mouth 3M. The side 02T of the terminal unit Ut may also have a recess 05 with a mouth 5M that also conforms to mouth 3M. Mouth 03M of one processing unit and mouth 5M of another processing unit or the terminal unit can be pressed against each other to seal both mouths (03M, 05M), forming a larger enclosed gas-tight space for accommodating the single slab 04. In other embodiments as shown in FIG. 5, the rear side 02F of each processing unit is flat, and the side 02T of the terminal unit Ut is also flat. Therefore, when the recess 03's mouth 03M is pressed against the rear flat side 02R of another processing unit or a flat side 02T of the terminal unit Ut to seal the mouth 03M, a smaller enclosed gas-tight space will be formed for accommodating slab 04.

In preferred embodiments of the invention, recess 03/05 has a bottom 03B/05B that is smaller than its mouth 03M/05M as shown in FIG. 4 and FIG. 5, to facilitate the slab 04 to pop up from recess 03/05 when it is being expanded to the closed-cell foam.

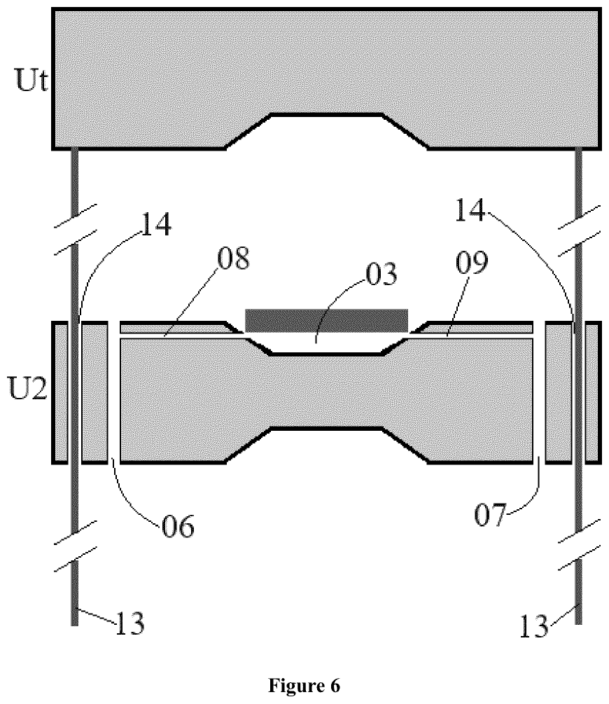

As shown in FIG. 6, each of the processing unit(s) such as unit U2 may include a gas entry conduit 08 configured for delivering or injecting a gas flow to the recess 03 through the main body 02; and a gas exit conduit 09 configured for releasing the gas within the recess 03 through the main body 02.

Each of the processing unit(s) such as unit U2 may further include a gas pumping channel 06 (through the main body 02 or not), and a gas releasing channel 07 (through the main body 02 or not). As such, the gas entry conduit 08 may be configured for diverting a gas flow from the gas pumping channel 06 to the recess 03 through the main body 02; and the gas exit conduit 09 may be configured for the gas within the recess 03 to exit into the gas releasing channel 07 through the main body 02.

The terminal unit Ut, unlike each of the processing units, does not have gas pumping channel 06, gas releasing channel 07, gas entry conduit 08 and gas exit conduit 09. In one design, each main body 02 may have 2, 3, 4 or more through holes 14 for the sliding rods 13 to pass through.

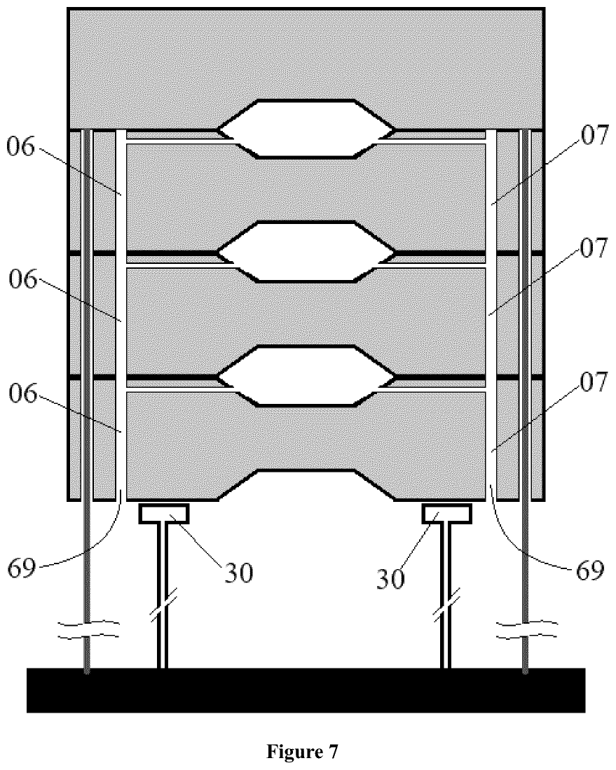

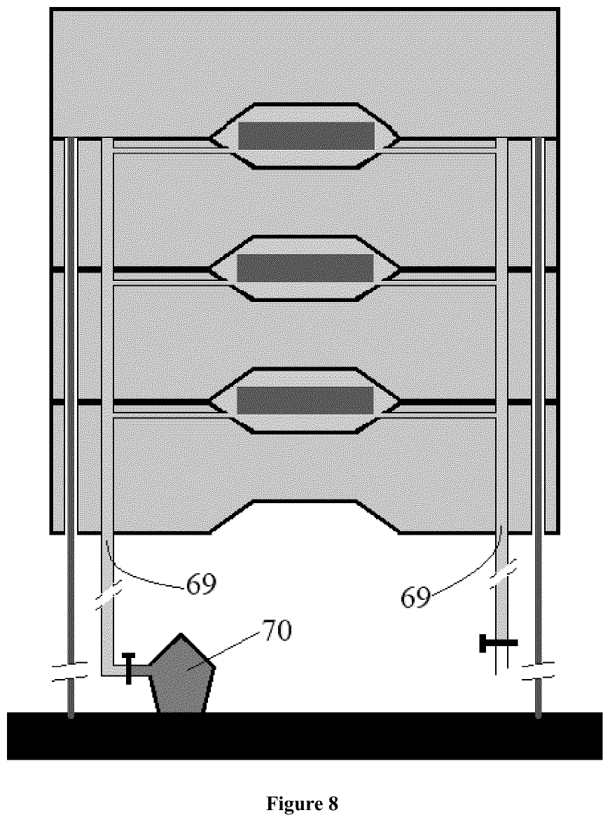

Engaging the processing units (U1, U2 . . . Un) and the terminal unit Ut with each other in step (ii) may be accomplished using any suitable technique. As shown in FIG. 7, the apparatus of the present invention may include a mechanical presser 30. The processing units (U1, U2 . . . Un) and the terminal unit Ut can be pressed against each other into an engaged mode using the mechanical presser 30. Gas pumping channel 06 in one processing unit is connected to that of neighboring unit(s). Gas releasing channel 07 in one processing unit is connected to that of neighboring unit(s). A sealed trans-unit gas system 69 is thus formed for the gas flow. As shown in FIG. 8, a gas source 70 may be used for delivering a gas medium around each of the slabs 04 through the sealed trans-unit gas system 69 and dissolving or diffusing the gas molecules into each of the slabs 04.

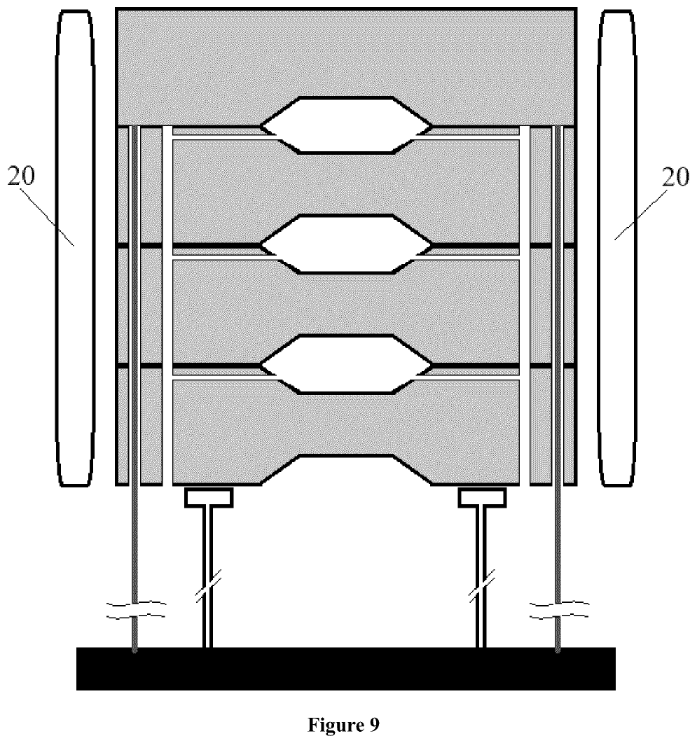

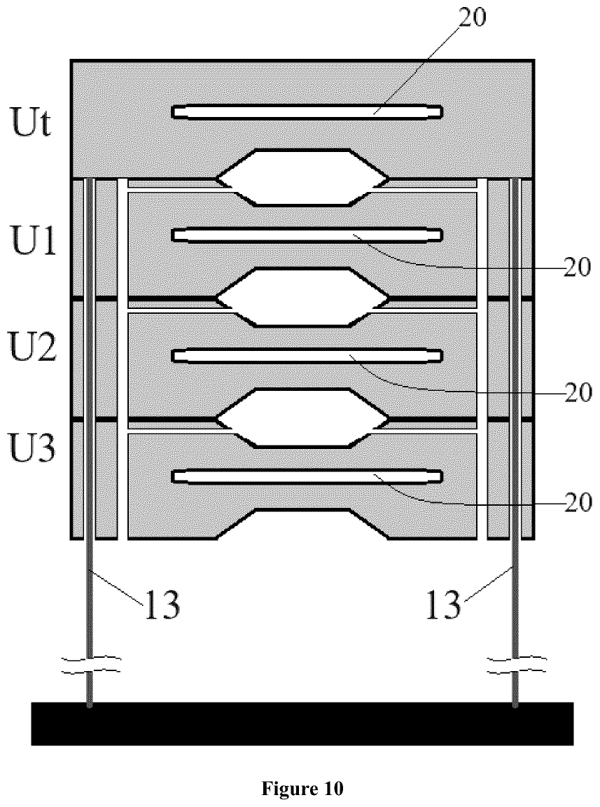

Referring to FIGS. 9 and 10, the apparatus of the present invention may include a heating and cooling system 20 for controlling the temperature of all the processing unit(s) and the terminal unit. For example, the heating and cooling system may be an external heater 20 as shown in FIG. 9 or internal heaters 20 as shown in FIG. 10.

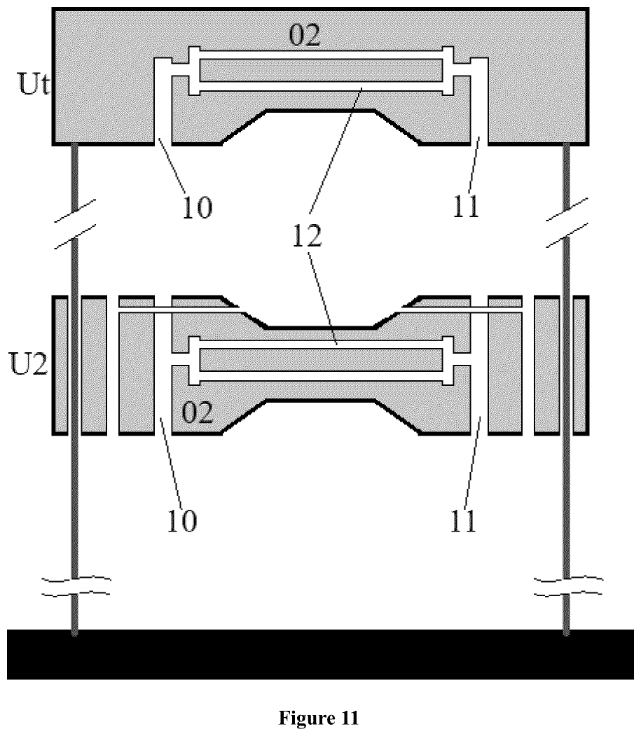

In an embodiment as shown in FIG. 11, the heating and cooling system 20 comprises a liquid pumping channel 10 (through the main body 02 or not); a liquid releasing channel 11 (through the main body 02 or not); and a liquid circulating pipeline network 12 within the main body 02 configured for transferring at least a portion of the liquid flow from the liquid pumping channel 10 to the liquid releasing channel 11, and for controlling the temperature of the main body 02 by thermal exchange between the liquid flow and the main body 02.

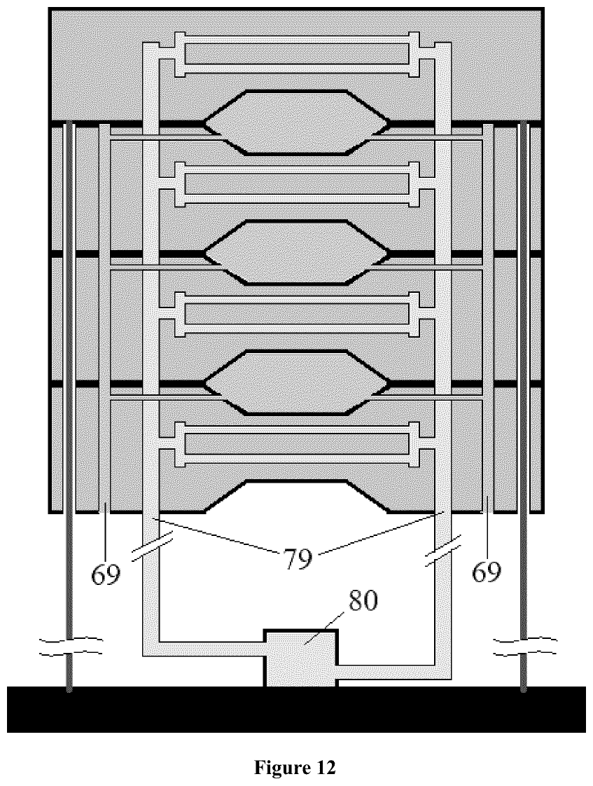

The processing units (U1, U2 . . . Un) and the terminal unit Ut can be pressed against each other using a mechanical presser 30. Liquid pumping channel 10 in one processing unit is connected to that of neighboring unit(s). Liquid releasing channel 11 in one processing unit is connected to that of neighboring unit(s). A sealed trans-unit liquid system 79 for the liquid flow as shown in FIG. 12 is thus formed. A liquid pump 80 may be employed for circulating a heated liquid flow such as oil through the sealed trans-unit liquid system 79. The sealed trans-unit gas system 69 and the sealed trans-unit liquid system 79 are completely isolated from each other.

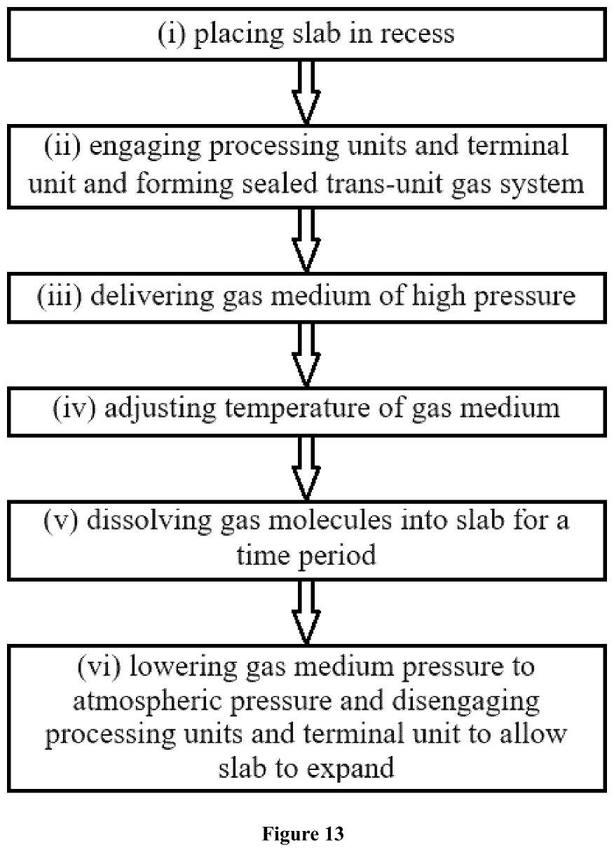

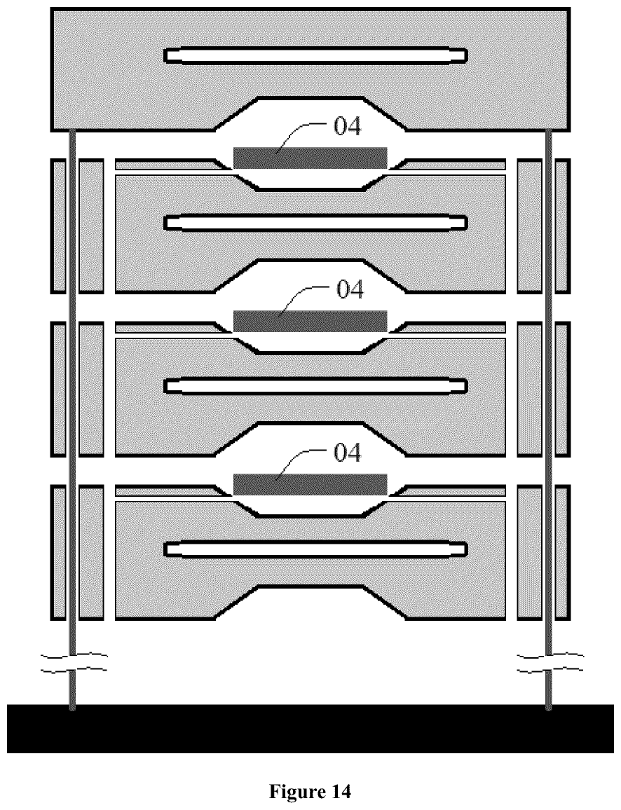

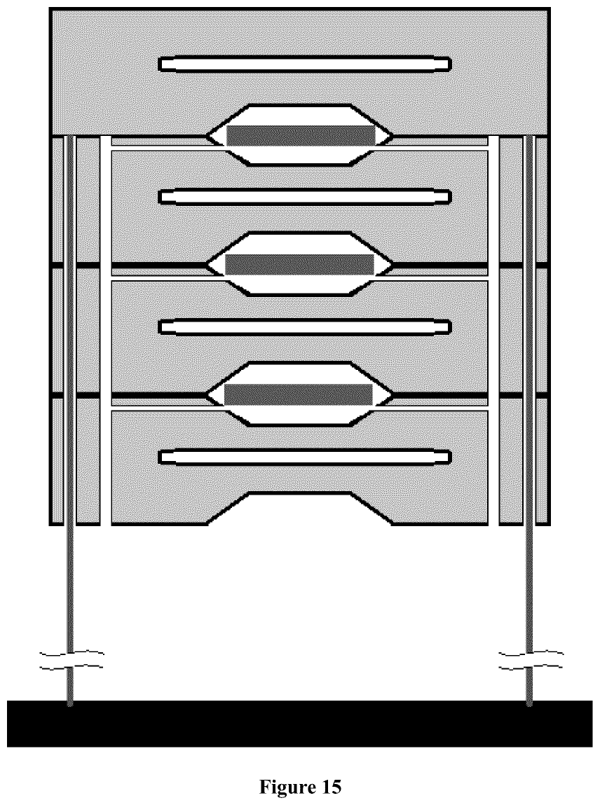

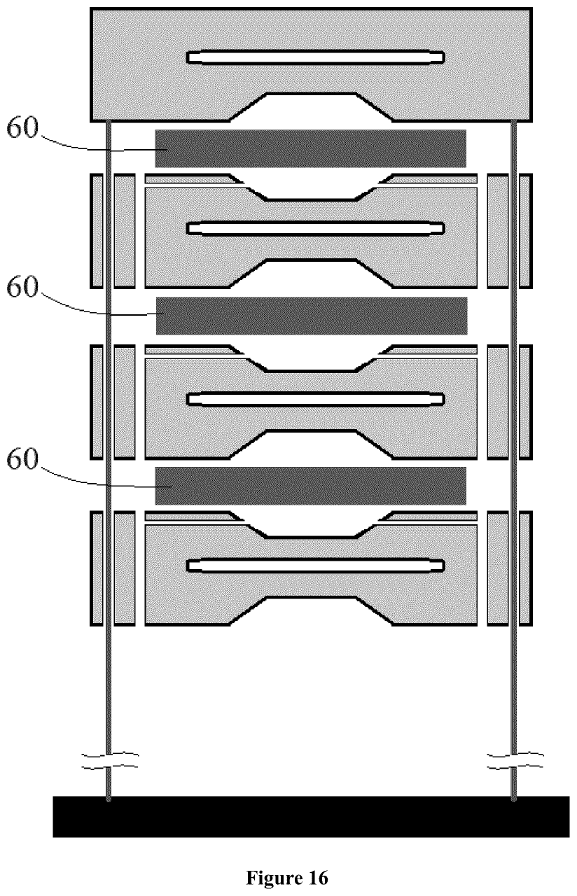

Another aspect of the invention provides a method of manufacturing a closed-cell foam using the apparatus as described above. As illustrated in FIG. 13, the method includes the following steps:
(i) placing one single slab 04 made of dense material having a density D0 in the recess 03, as shown in FIG. 14;
(ii) engaging the processing units (U1, U2 . . . Un) and the terminal unit Ut with each other by pressing or clamping them against each other as shown in FIG. 15, so that the recess 03's mouth 03M is pressed against the rear side 02R of another processing unit or a side 02T of the terminal unit Ut to seal the mouth 03M;
(iii) delivering a gas medium with a predetermined pressure P that is higher than the atmospheric pressure P0 around each of the slabs 04 through the sealed trans-unit gas system 69;
(iv) adjusting the temperature of the gas medium as well as the slabs 04 to a predetermined temperature T using the heating and cooling system 20;
(v) dissolving or diffusing an amount of the gas molecules into each of the slabs 04 under the predetermined pressure P and the predetermined temperature T for a predetermined time period t;
(vi) lowering the pressure of the gas medium around each of the slabs 04 down to the atmospheric pressure P0 and disengaging the processing units (U1, U2 . . . Un) and the terminal unit Ut from each other as shown in FIG. 16 (preferably a rapid depressurization), and allowing each of the slabs 04 be expanded to the closed-cell foam 60 having a density Df<D0. This step will turn the slab 04 into a larger foam sheet 60.

In step (ii), gas pumping channel 06 in one processing unit may be connected to that of neighboring unit(s) and gas releasing channel 07 in one processing unit may be connected to that of neighboring unit(s), forming a sealed trans-unit gas system 69 for the gas flow. Then step (iii) may become delivering a gas medium with a predetermined pressure P that is higher than the atmospheric pressure P0 around each of the slabs 04 through the sealed trans-unit gas system 69.

In some embodiments, the method further comprises step (vii) of applying the closed-cell foam 60 having a density Df in a final product for end-users or consumers without changing the density Df any further. In other words, secondary foaming process of the closed-cell foam 60 is not needed and it can be eliminated or omitted. The slab 04 may be obtained from industrial suppliers, and it remains “as is” when it is subject to step (i). As such, the present invention provides a method for a one-step foaming preparation of a foam board such as pure PVDF foam board.

In some embodiments, the method further comprises a step of aligning the processing units (U1, U2 . . . Un) and the terminal unit Ut with one or more sliding rods 13 before step (ii). In step (iii), adjusting the temperature of the gas medium as well as the slabs 04 to a predetermined temperature may be carried out using a sealed trans-unit liquid system 79 to circulate a heated liquid flow such as oil within bodies of the processing units (U1, U2 . . . Un) and the terminal unit Ut.

The slab 04 may be made of a dense material selected from polyvinylidene difluoride (PVDF), Perfluoroalkoxy alkanes (PFA), Polypropylene (PP), Polyethylene (PE), Polyamide (PA), Polyvinyl chloride (PVC), Ethylene-vinyl acetate (EVA), Thermoplastic polyurethane (TPU), Polyether ether ketone (PEEK), block copolymers of polyether and polyamide such as Pebax®, or any combination thereof.

The gas medium in the method may be any suitable inert gas or a mixture of gases. For example, the gas medium or gas flow may be carbon dioxide or a mixture of carbon dioxide and nitrogen with a molar ratio of carbon dioxide to nitrogen in a range of from 3:1 to 9:1. The predetermined pressure P may be in the range of from 2 to 100 MPa, preferably in the range of from 5 to 60 MPa, and more preferably in the range of from 10 to 30 MPa. The predetermined temperature T may be in the range of from 50° C. to 300° C., preferably in the range of from 100° C. to 200° C., and more preferably in the range of from 130° C. to 180° C. The predetermined time period t may be in the range of from 1 hours to 48 hours, preferably in the range of from 2 hours to 30 hours, and more preferably in the range of from 3 hours to 18 hours.

In some embodiments, the method of the present invention does not use any chemical blowing agents to generate gas by decomposition of a chemical heated above its degradation temperature, such as azodicarbonamide, azodiisobutyronitile, sulfonylsemicarbazide, 4,4-oxybenzene, barium azodicarboxylate, 5-Phenyltetrazole, p-toluenesulfonylsemicarbazide, diisopropyl hydrazodicarboxylate, 4,4′-oxybis(benzenesulfonylhydrazide), diphenylsulfone-3,3′-disulfohydrazide, isatoic anhydride, N,N′-dimethyl-N,N′dmitroterephthalamide, citric acid, sodium bicarbonate, monosodium citrate, anhydrous citric acid, trihydrazinotriazine, N,N′-dinitroso-pentamethylenetetramine, and p-toluenesulfonylhydrazide. The method of the present invention does not use any nucleating agent such as calcium carbonate, calcium sulfate, magnesium hydroxide, magnesium silicate hydroxide, calcium tungstate, magnesium oxide, lead oxide, barium oxide, titanium dioxide, zinc oxide, antimony oxide, boron nitride, magnesium carbonate, lead carbonate, zinc carbonate, barium carbonate, calcium silicate, alumina silicate, carbon black, graphite, non-organic pigments, alumina, molybdenum disulfide, zinc stearate, PTFE particles, immiscible polymer particles, and calcium metasilicate. A preferred nucleating agent is calcium carbonate.

Optionally, the PVDF of the invention may also contain additives typically added to PVDF formulations, including but not limited to impact modifiers, UV stabilizers, plasticizers, fillers, coloring agents, pigments, dyes, antioxidants, antistatic agents, surfactants, toner, pigments, and dispersing aids.

In preferred embodiments, the method of the invention is employed for producing a closed-cell foam 60 with Barcol hardness Y. The time period t (in the unit of hour) for dissolving or diffusing an amount of the gas molecules into each of the slabs 04 may be determined by an equation t=(100−Y)/C, wherein C is a constant depending on the predetermined pressure P and the predetermined temperature T. For example, in producing a closed-cell PVDF foam 60 with Barcol hardness Y, the time period t (in the unit of hour) for dissolving or diffusing an amount of the gas molecules into each of the slabs 04 may be determined by an equation t=(100−Y)/5, wherein the gas is CO2, the predetermined pressure P=15 MPa, and the predetermined temperature T=155° C. The equation works best when t ranges from 4 to 12 hours and Y, accordingly, ranges from 80 B to 40 B.

In the following description, apparatus 01 of the present invention is exemplified as a device named multilayer plate heat exchanger, and the method for manufacturing a closed-cell foam falls within the domain of physical foaming technology. Each heat exchange plate (or layer) of the multilayer plate heat exchanger is an example of the processing units (U1, U2 . . . Un) and the terminal unit Ut. Each layer is equipped with two foaming inert gas pipelines, which are examples of gas entry conduit 08 and gas exit conduit 09. The two foaming inert gas pipelines are connected to center slots, which are examples of recess 03 or 03&05, for gas to flow in and flow out. Each heat exchange plate is also equipped with a circulating liquid pipeline for heating purpose, which is an example liquid circulating pipeline network 12 or the sealed trans-unit liquid system 79. A loop in plate heat exchanger that circulates heated liquid may be employed for controlling the temperature of all the processing unit(s) and the terminal unit. The circulating heating liquid is typically a heat transfer oil.

In exemplary embodiments, the method of the invention enables the production of pure PVDF foam board material (an example of the closed-cell foam 60) without the need for physical blending of raw materials or chemical modification for the preparation of slab 04, offering a straightforward process devoid of chemical waste. To-be-foamed embryos (an example of slab 04) may be made by pressing or extruding pure PVDF material without the addition of other chemicals.

Engaging the processing units (U1, U2 . . . Un) and the terminal unit Ut with each other in step (ii) may be accomplished using any suitable technique. For example, fixed screws at the four corners of the plate heat exchanger can be movable and can be opened & closed by mechanical stretching and pushing.

The inert gas for blowing/foaming (an example of gas flow in the sealed trans-unit gas system 69 or the gas medium around each of the slabs 04) can be carbon dioxide or a mixture of carbon dioxide and nitrogen. For a mixture of carbon dioxide and nitrogen, the molar ratio of carbon dioxide to nitrogen may be in a range of from 3:1 to 9:1.

The preparation of PVDF foam board material 60 involves introducing inert foaming gas with a pressure of P into the gas circuit under the foaming temperature T controlled by the circulating heating liquid loop. By adjusting the ratio of carbon dioxide to nitrogen under certain foaming time conditions t, PVDF foam boards with different foaming magnitude ratios can be obtained to serve different purposes of foam boards 60.

Steps (iii) and (iv) of the method may be carried out nearly simultaneously. The temperature of the gas medium as well as the slabs 04 is adjusted to a predetermined temperature T (such as the required foaming temperature T for PVDF). Simultaneously, an inert foaming gas with a predetermined pressure P that is higher than the atmospheric pressure P0 is introduced into recess 03 or 03&05 around each of the slabs 04 through the sealed trans-unit gas system 69.

In the preparation of pure PVDF foam board material 60 using the method of the present invention, the foaming size/ratio of the PVDF foam material can be regulated in steps (iii) and (iv) by adjusting the heating temperature T and inert blowing gas pressure P settings of the plate heat exchanger. For PVDF foam, the circulating temperature T is set at 130° C. to 180° C., and the inert gas pressure P ranges from 10 to 30 MPa.

Additionally, by modifying the duration of foaming time t and maintaining the foaming inert gas pressure P inside the plate heat exchanger, the hardness of the PVDF foam material can be controlled, facilitating its application across diverse industries.

Foaming temperature T and foaming gas pressure P are maintained in step (v) until the inert gas reaches a certain degree of dissolution equilibrium in the small pieces of pure PVDF solid plate embryos (slab 04). The time required for the foaming inert gas to reach the predetermined dissolution equilibrium in the small pieces of pure PVDF solid plate embryos is defined as the foaming time t.

By adjusting the foaming time t, PVDF foam boards 60 with different Barcol hardness values can be obtained to achieve different purposes of foam boards.

In step (vi), the pressure P of the inert gas pipeline inside the heat exchanger is released to atmospheric pressure P0, then the plate heat exchanger is opened or disengaged, allowing the small pieces of pure PVDF solid plate embryos (slab 04) to undergo physical foaming expansion. Subsequently, the foam product 60 is taken out from apparatus 01 or multilayer plate heat exchanger.

As an embodiment of apparatus 01, the present invention provides a plate heat exchanger. The exchanger is multilayered (Ut, U1, U2, U3 . . . ), can be opened and closed, and is equipped with circulating liquid heating pipelines 12 and inert foaming gas inlet and outlet pipelines (08, 09). Each layer of the plate heat exchanger is machined with a slot (03 or 03&05) for placing the pure PVDF solid board foaming embryos 04.

In an embodiment, the present invention provides a method for one-step foaming preparation of pure PVDF foam board 60: provide pure PVDF solid board foaming embryos 04 which may be extruded, injection molded, or hot pressed from a raw polymeric material; open the multilayer plate heat exchanger and place small pieces of pure PVDF solid plates 04 into the specially designed slots (03 or 03&05) between the layers (units Ut, U1, U2, U3 . . . ) of the multilayer plate heat exchanger; close the multilayer plate heat exchanger and set the circulating heating liquid temperature loop of the plate heat exchanger to the required foaming temperature T; simultaneously, introduce inert foaming gas with a pressure of P into the gas circuit of the plate heat exchanger; maintain the circulating temperature T and inert foaming gas pressure P until the inert gas reaches a certain degree of dissolution equilibrium in the small pieces of pure PVDF solid plate embryos 04; the time required for the foaming inert gas to reach the set dissolution equilibrium in the small pieces of pure PVDF solid plate embryos is defined as the foaming time t; reduce the pressure of the inert gas pipeline inside the heat exchanger to atmospheric pressure P0, and then open the plate heat exchanger, allowing the small pieces of pure PVDF solid plate embryos 04 to undergo physical foaming expansion; take the foam 60 out of the slot or the space between layers (units Ut, U1, U2, U3 . . . ).

In various embodiments, the inert foaming gas may be carbon dioxide or a mixture of carbon dioxide and nitrogen. By adjusting the molar ratio of carbon dioxide to nitrogen in the inert foaming gases, PVDF foam boards with different foaming magnitudes can be obtained. By adjusting the foaming time t of the material in the plate heat exchanger, PVDF foam boards with different Barcol hardness values can be obtained.

Advantageously, the present invention provides a method for preparing polymer PVDF foam material 60 with a porous structure using a specially designed multilayer plate heat exchanger 01 and inert foaming gas. With this method, a polymer foam material 60 with a porous structure, high porosity, high foaming ratio, and excellent bubble morphology can be obtained in a single foaming step, without the need for physical blending or chemical modification. The process is simple and generates no pollution. Moreover, when preparing polymer PVDF foam material 60 with a porous structure using this method, the foaming ratio and Barcol hardness of the foam material can be adjusted by adjusting the inert gas mixing ratio and foaming time. Furthermore, the multilayer plate heat exchanger has two or more layers (units Ut, U1, U2, U3 . . . ) of heat exchange plates, and the number of layers determines the quantity of each foaming operation. Each plate is machined with a slot (03, 03&05) at the center, the size of which depends on the size of the pure PVDF solid plate embryo 04. The fixed screws at the four corners of the plate heat exchanger are movable and can be opened and closed by mechanical stretching and pushing. Additionally, the inert gas foaming pressure P is set to 10-30 MPa in this method. The effect of forming a porous structure in the foaming embryo through one-time foaming is improved with this specified one-time foaming pressure P.

In a variety of embodiments, each heat exchange plate of the multilayer plate heat exchanger is equipped with a circulating liquid pipeline for heating purpose, with the circulating heating liquid typically being a heat transfer oil. Each layer is equipped with two inert gas pipelines, connected to the center slots. The circulating temperature T is set to 130° C. to 180° C., and the inert gas pressure P is set to 10 to 30 MPa. The inert gas can be carbon dioxide or a mixture of carbon dioxide and nitrogen. For a mixture of carbon dioxide and nitrogen, the molar ratio of carbon dioxide to nitrogen is 9:1 to 3:1. The foaming time t can vary from 3 hours to 18 hours.

### Examples

Example 1 provides a method for one-step foaming preparation of pure PVDF foam board having a Barcol hardness of 80 B. The method comprises the following stages.

Stage 1: Use commercially available pure PVDF solid boards from Solvay's Solef brand, cut it into 3 pieces of small boards each measuring 200 mm in length, 200 mm in width, and 10 mm in thickness each.

Stage 2: Place the above 3 pieces of small pure PVDF solid boards into the specially designed slots between the layers of a 3-layer plate heat exchanger.

Stage 3: Close the 3-layer plate heat exchanger and set the circulating liquid temperature loop of the plate heat exchanger to the predetermined foaming temperature T=155° C. Simultaneously, introduce inert foaming gas CO2 with a pressure of P=15 MPa into the gas circuit of the plate heat exchanger.

Stage 4: Maintain the circulating temperature T=155° C. and inert foaming gas pressure P=15 MPa for 4 hours.

Stage 5: Reduce or relive the pressure P of the inert gas pipeline inside the heat exchanger to atmospheric pressure P0, then open the plate heat exchanger, allowing the 3 small pieces of pure PVDF solid boards 04 to undergo physical foaming expansion, to produce PVDF foam boards 60. The PVDF foam boards 60 are then removed from the plate heat exchanger.

Stage 6: Cut the obtained PVDF foam boards 60 in half from the center and measure the Barcol hardness at the central position using a hardness tester. Take the average value of the measured hardness of these 3 pieces of PVDF foam boards 60, and the result was a value of Barcol hardness 80B. The Barcol hardness test characterizes the indentation hardness of materials by measuring the depth of penetration of an indenter into a sample. The Barcol impresser is a handheld device that assesses material hardness. When pressed against the material, the tip indents, and the hardness determines how far it penetrates. The result is read on an analog dial. Barcol hardness is measured on a scale from 0 to 100 B.

Example 2 is the same as Example 1, except that stage 4 maintains the circulating temperature T=155° C. and inert foaming gas pressure P=15 MPa for 6 hours. As a result, the method in Example 2 provides pure PVDF foam boards 60 having a Barcol hardness of 70 B.

Example 3 is the same as Example 1, except that stage 4 maintains the circulating temperature T=155° C. and inert foaming gas pressure P=15 MPa for 8 hours. As a result, the method in Example 3 provides pure PVDF foam boards 60 having a Barcol hardness of 60 B.

Example 4 is the same as Example 1, except that stage 4 maintains the circulating temperature T=155° C. and inert foaming gas pressure P=15 MPa for 10 hours. As a result, the method in Example 4 provides pure PVDF foam boards 60 having a Barcol hardness of 50 B.

Example 5 is the same as Example 1, except that stage 4 maintains the circulating temperature T=155° C. and inert foaming gas pressure P=15 MPa for 12 hours. As a result, the method in Example 4 provides pure PVDF foam boards 60 having a Barcol hardness of 40 B.

A linear relationship Y=100−C×X is proposed based on the data of Examples 1-5, wherein Y stands for the Barcol hardness of a polymer foam product 60 and Y ranges from 0 to 100 B (preferably 40-80 B), C is a constant, and X stands for the time t (in the unit of hour) of maintaining a certain circulating temperature T and a certain inert foaming gas pressure P in diffusing gas into the polymer 04 (stage 4). For PVDF, Y=100−5×X wherein Y stands for the Barcol hardness of PVDF foam product 60, C=5, and X stands for the hours of maintaining the circulating temperature T=155° C. and inert foaming gas pressure P=15 MPa in diffusing CO2 gas into PVDF. The linear relationship Y=100−5×X is relatively strict when X ranges from 4 to 12 hours and Y, accordingly, ranges from 80 B to 40 B.

In the foregoing specification, embodiments of the present invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicant to be the scope of the invention, is the literal and equivalent scope of the set of claims that issue from this application, in the specific form in which such claims issue, including any subsequent correction.

1. An apparatus 01 for manufacturing a closed-cell foam comprising one, two or more processing units (U1, U2 . . . Un) and a terminal unit Ut, wherein each of the processing unit(s) includes:
a main body 02 with a front side 02F and a rear side 02R, wherein the front side 02F has a recess 03 for partially or fully accommodating one single slab 04 made of dense material with a density D0, wherein the slab 04 is to be expanded to the closed-cell foam 60 having a density Df<D0, and wherein the recess 03's mouth 03M can be pressed against the rear side 02R of another processing unit or a side 02T of the terminal unit Ut to seal the mouth 03M;
a gas entry conduit 08 configured for delivering a gas flow to the recess 03 through the main body 02;
a gas exit conduit 09 configured for releasing the gas within the recess 03 through the main body 02; and
a heating and cooling system 20 for controlling the temperature of all the processing unit(s) and the terminal unit.

2. The apparatus according to claim 1, wherein each of the processing unit(s) further comprises a gas pumping channel 06 and a gas releasing channel 07; wherein the gas entry conduit 08 is configured for diverting a gas flow from the gas pumping channel 06 to the recess 03 through the main body 02; and wherein the gas exit conduit 09 is configured for the gas within the recess 03 to exit into the gas releasing channel 07 through the main body 02.

3. The apparatus according to claim 1, wherein the processing units and the terminal unit are stacked or arranged in serial vertically or horizontally, preferably vertically with the terminal unit located at the highest position.

4. The apparatus according to claim 1, wherein the slab 04 is made of a dense material selected from polyvinylidene difluoride (PVDF), Perfluoroalkoxy alkanes (PFA), Polypropylene (PP), Polyethylene (PE), Polyamide (PA), Polyvinyl chloride (PVC), Ethylene-vinyl acetate (EVA), Thermoplastic polyurethane (TPU), Polyether ether ketone (PEEK), block copolymers of polyether and polyamide such as Pebax®, or any combination thereof.

5. The apparatus according to claim 1, wherein the terminal unit Ut, unlike each of the processing units, does not have gas entry conduit 08 and gas exit conduit 09.

6. The apparatus according to claim 1, wherein the rear side 02F of each processing unit is flat, and wherein said side 02T of the terminal unit Ut is also flat; or
wherein the rear side 02F of each processing unit has a recess 05 with a mouth 5M that conforms to mouth 3M, wherein the side 02T of the terminal unit Ut has a recess 05 with a mouth 5M that also conforms to mouth 3M; and wherein mouth 03M of one processing unit and mouth 5M of another processing unit or the terminal unit can be pressed against each other to seal both mouths (03M, 05M), forming a larger enclosed gas-tight space (03&05) for accommodating the single slab 04.

7. The apparatus according to claim 1, further comprising 2, 3, 4 or more sliding rods 13 to align all the processing units and the terminal unit in serial, and wherein each main body 02 has 2, 3, 4 or more through holes 14 for the sliding rods 13 to pass through.

8. The apparatus according to claim 2, further comprising a mechanical presser 30, and wherein the processing units (U1, U2 . . . Un) and the terminal unit Ut can be pressed against each other using the mechanical presser 30 so that (1) gas pumping channel 06 in one processing unit is connected to that of neighboring unit(s), and (2) gas releasing channel 07 in one processing unit is connected to that of neighboring unit(s), forming a sealed trans-unit gas system 69 for the gas flow.

9. The apparatus according to claim 8, further comprising a gas source 70 for delivering a gas medium around each of the slabs 04 through the sealed trans-unit gas system 69 and dissolving or diffusing the gas molecules in each of the slabs 04.

10. The apparatus according to claim 1, wherein the heating and cooling system 20 comprises a liquid pumping channel 10; a liquid releasing channel 11; and a liquid circulating pipeline network 12 within the main body 02 configured for transferring at least a portion of the liquid flow from the liquid pumping channel 10 to the liquid releasing channel 11, and controlling the temperature of the main body 02 by thermal exchange between the liquid flow and the main body 02.

11. The apparatus according to claim 10, wherein the processing units (U1, U2 . . . Un) and the terminal unit Ut can be pressed against each other using a mechanical presser 30 so that (1) liquid pumping channel 10 in one processing unit is connected to that of neighboring unit(s), and (4) liquid releasing channel 11 in one processing unit is connected to that of neighboring unit(s); forming a sealed trans-unit liquid system 79 for the liquid flow.

12. The apparatus according to claim 11, further comprising a liquid pump 80 for circulating a heated liquid flow through the sealed trans-unit liquid system 79.

13. A method of manufacturing a closed-cell foam using the apparatus according to claim 1, comprising:
(i) placing one single slab 04 made of dense material having a density D0 in the recess 03;
(ii) engaging the processing units (U1, U2 . . . Un) and the terminal unit Ut with each other by pressing or clamping them against each other, so that the recess 03's mouth 03M is pressed against the rear side 02R of another processing unit or a side 02T of the terminal unit Ut to seal the mouth 03M;
(iii) delivering a gas medium with a predetermined pressure P that is higher than the atmospheric pressure P0 around each of the slabs 04;
(iv) adjusting the temperature of the gas medium as well as the slabs 04 to a predetermined temperature T using the heating and cooling system 20;
(v) dissolving or diffusing an amount of the gas molecules into each of the slabs 04 under the predetermined pressure P and the predetermined temperature T for a predetermined time period t;
(vi) lowering the pressure of the gas medium around each of the slabs 04 down to the atmospheric pressure P0 and disengaging the processing units (U1, U2 . . . Un) and the terminal unit Ut from each other, to allow each of the slabs 04 be expanded to the closed-cell foam 60 having a density Df<D0.

14. The method according to 13, wherein each of the processing unit(s) further comprises a gas pumping channel 06 and a gas releasing channel 07;
wherein, in step (ii), the gas pumping channel 06 in one processing unit is connected to that of neighboring unit(s) and the gas releasing channel 07 in one processing unit is connected to that of neighboring unit(s), forming a sealed trans-unit gas system 69 for the gas flow; and
wherein, in step (iii), a gas medium with a predetermined pressure P that is higher than the atmospheric pressure P0 is delivered to around each of the slabs 04 through the sealed trans-unit gas system 69.

15. The method according to 13, further comprising step (vii) of applying the closed-cell foam 60 having a density Df in a final product for end-users or consumers without further changing of the density Df or hardness of the foam 60; wherein the slab 04 is obtained from industrial suppliers, and it remains “as is” when it is subject to step (i).

16. The method according to 13, wherein the slab 04 is made of a dense material selected from polyvinylidene difluoride (PVDF), Perfluoroalkoxy alkanes (PFA), Polypropylene (PP), Polyethylene (PE), Polyamide (PA), Polyvinyl chloride (PVC), Ethylene-vinyl acetate (EVA), Thermoplastic polyurethane (TPU), Polyether ether ketone (PEEK), block copolymers of polyether and polyamide such as Pebax®, or any combination thereof, and
wherein the gas medium is carbon dioxide or a mixture of carbon dioxide and nitrogen with a molar ratio of carbon dioxide to nitrogen in a range of from 3:1 to 9:1.

17. The method according to 13, wherein the predetermined pressure P is in the range of from 2 to 100 MPa, preferably in the range of from 5 to 60 MPa, and more preferably in the range of from 10 to 30 MPa;
wherein the predetermined temperature T is in the range of from 50° C. to 300° C., preferably in the range of from 100° C. to 200° C., and more preferably in the range of from 130° C. to 180° C.; and
wherein the predetermined time period t is in the range of from 1 hours to 48 hours, preferably in the range of from 2 hours to 30 hours, and more preferably in the range of from 3 hours to 18 hours.

18. The method according to 13 for producing a closed-cell foam 60 with Barcol hardness Y, wherein the time period t (in the unit of hour) for dissolving or diffusing an amount of the gas molecules into each of the slabs 04 is determined by an equation t=(100−Y)/C, wherein C is a constant depending on the predetermined pressure P and the predetermined temperature T.

19. The method according to 13, for producing a closed-cell PVDF foam 60 with Barcol hardness Y, wherein the time period t (in the unit of hour) for dissolving or diffusing an amount of the gas molecules into each of the slabs 04 is determined by an equation t=(100−Y)/5,
wherein the gas is CO2, the predetermined pressure P=15 MPa, and the predetermined temperature T=155° C.; and
preferably wherein t ranges from 4 to 12 hours and Y, accordingly, ranges from 80 B to 40 B.

20. The method according to 13, further comprising aligning the processing units (U1, U2 . . . Un) and the terminal unit Ut with one or more sliding rods 13 before step (ii); wherein said adjusting the temperature of the gas medium as well as the slabs 04 to a predetermined temperature in step (iii) is carried out using a sealed trans-unit liquid system 79 to circulate a heated liquid flow such as oil within bodies of the processing units (U1, U2 . . . Un) and the terminal unit Ut.
